(19) United States
(12) Patent Application Publication
(10) Pub. No.: US 2016/0378741 A1
(43) Pub. Date: Dec. 29, 2016

(54) CENTRALLY MAINTAINING AND ANALYZING COMMENTS ON DOCUMENTS

(71) Applicant: Microsoft Technology Licensing, LLC, Redmond, WA (US)

(72) Inventors: Christopher Lee Mullins, Sammamish, WA (US); Jonathan Edgar Fay, Woodinville, WA (US)

(21) Appl. No.: 14/754,547

(22) Filed: Jun. 29, 2015

(51) Int. Cl. G06F 17/24; G06F 17/27

(52) U.S. Cl. CPC G06F 17/241; G06F 17/27; G06F 17/245

(57) ABSTRACT

A facility for analyzing comments attached to electronic documents is described. The facility compiles a data set reflecting comments attached to each of a plurality of electronic documents. The facility analyzes the compiled data set to generate at least one comment analysis result, and outputs the generated at least one comment analysis result.

### BACKGROUND

Electronic documents include various types, such as word processing documents containing mostly text; spreadsheets containing mostly numbers and formulae organized into a grid; slideshow documents organized into a sequence of slides having room for minimal content based on the typical need for them to be legible at a distance; business drawings in which text is associated with shapes connected in a particular configuration, etc.

It is common for a document to be a subject of discussion among two or more people. Various conventional approaches are used for such discussions, including participants (1) inserting comments into the document, and (2) using an out-of-band communication channel, such as exchanges of email messages or instant messages, telephone conversations, etc.

### BRIEF DESCRIPTION OF THE DRAWINGS

FIG. 1 is a network diagram showing the environment in which the facility operates in some embodiments.

FIG. 2 is a block diagram showing some of the components typically incorporated in at least some of the computer systems and other devices on which the facility operates.

FIGS. 3-5 are display diagrams showing the editing and display of a document incorporating a shared document fragment.

FIG. 6 is a flow diagram showing steps typically performed by the facility in some embodiments in order to incorporate a document fragment into a document, and adjust the mode of its incorporation.

FIG. 7 is a flow diagram showing steps typically performed by the facility in some embodiments in order to materialize a document containing shared fragments.

FIG. 8 is a table diagram showing sample contents of a fragment directory table used by the facility in some embodiments to store information about fragments.

FIG. 9 is a table diagram showing sample contents of a fragment version table used by the facility in some embodiments to store information about fragment versions.

FIG. 10 is a table diagram showing sample contents of a fragment version instance table used by the facility in some embodiments to store information about fragment version instances.

FIG. 11 is a table diagram showing sample contents of a fragment version instance content table used by the facility in some embodiments to store fragment version instance content.

FIGS. 12 and 13 are display diagrams showing a sample visual user interface used by the facility in some embodiments in order to create, display, and interact with document comments.

FIGS. 14 and 15 are flow diagrams showing steps typically performed by the facility in connection with presenting the visual user interface shown in FIGS. 12 and 13.

FIG. 16 is a flow diagram showing steps typically performed by the facility in some embodiments in order to register a newly-created comment fragment.

FIG. 17 is a table diagram showing sample contents of a comment tracking table maintained by the facility in some embodiments in order to centrally represent document comments created by the facility as a basis for comment analysis.

FIG. 18 is a flow diagram showing steps typically performed by the facility in some embodiments in order to update comment analysis results.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for analyzing comments attached to electronic documents is described. The facility compiles a data set reflecting comments attached to each of a plurality of electronic documents, potentially including specific sections within the document. The facility analyzes the compiled data set to generate at least one comment analysis result, and outputs the generated at least one comment analysis result.

### DETAILED DESCRIPTION

The inventors have identified significant disadvantages with conventional approaches to discussing documents. In particular, the inventors have recognized that all of these conventional approaches fail to capture substantial informational value of such discussions to the participants and others. First, discussions via some channels such as telephone and instant messaging are ephemeral, in that no substance of the discussion is persistently stored, effectively discarding the informational value of such discussions. For conventional discussion channels that do persistently store substance of the discussion, such as email or inserting comments directly in the document, the substance of the discussion ends up stored in “silos”—locations where it is difficult to access and analyze, and its informational value is thus buried.

In order to overcome these disadvantages, the inventors have conceived of and reduced to practice a software and/or hardware facility for centrally maintaining and analyzing comments on documents (“the facility”). In various embodiments, the facility provides a variety of valuable information that can be continuously updated based upon recurrently or continuously analyzing the dynamic authoring of both documents and comments thereon.

In some embodiments, the facility provides threaded views of a group of comments, such as a group of comments that relate, directly or indirectly, to the same document, group of documents, or portion of a document.

In some embodiments, the facility identifies valued document reviewers and/or commenters. In doing so, in various environments, for each user, the facility considers comments made by the user, including the volume of comments, reflected in such measures as number, frequency, or recency; the quality of comments, including actions taken by others with respect to the user's comments, including viewing them, responding to them, forwarding them, scoring them, following links from them into documents, etc.

In some embodiments, the facility identifies users who frequently ask or answer questions in document comments.

In some embodiments, the facility performs analysis of comments to identify important documents or portions of documents. In some cases, this is referred to as “identifying hotspots.” In various embodiments, such analysis involves the volume of comments, reflected in such measures as number, frequency, or recency; the identity of users who comment, including values ascribed to these users; various natural language processing techniques that the facility applies to textual contents of comments; etc.

In some embodiments, the facility identifies documents and comments in a particular “space.” In various embodiments, the facility performs such identification based upon documents that share a particular explicit category, such as “employee evaluation”; documents or comments that share a particular attribute, such as those expressed in the French language; documents that are of a particular type, such as business drawing documents; documents or comments with respect to which users in a particular group of users have taken a particular kind action, such as creating, contributing to, viewing, recommending, evaluating, or commenting on; various kinds of lexical analysis, including search queries, natural language processing summaries and other processing techniques, etc.

In some embodiments, the facility leverages identification of documents in spaces as a basis for constraining various kinds of analysis it performs, such as identifying valued document reviewers in a space, those who pose or answer frequent questions in a space, important documents or portions of documents in the space, etc. In some cases, this is referred to as “identifying experts.”

In some embodiments, the facility identifies users who are part of a particular group of users. In various embodiments, the facility performs such identification on the basis of position; subtrees and/or levels within an organizational hierarchy; rank, such as military rank; qualification, such as a professional engineering licensure; job classification; subject matter area specialty; employer; age; sex; document and other data access rights; shared actions or activities; geographic location, including time zone; affinity groups; etc.

In some embodiments, the facility leverages identification of groups of users as a basis for constraining various kinds of analysis it performs, such as identifying valued document reviewers among a group, those who pose or answer frequent questions among a group, important documents or portions of documents among a group, etc. In some embodiments, the facility applies such constraints to individual users, such as to identify important documents or portions of documents to a user. In some embodiments, the facility applies these and similar kinds of analysis to recommend documents or portions of documents that are likely to be of interest to a particular user or a group of users.

In some embodiments, the facility stores both document content and document comments using a construct called a “fragment,” which is a unit of storage represented separately by the facility. A document is comprised of a single content fragment called a “root fragment,” which can directly contain content, as well as containing fragment references referring to other content fragments. Those fragments referred to by the root fragment can themselves directly contain content and fragment references to other fragments, and so on. When a document is opened, the facility typically collects and synthesizes its contents by retrieving the root fragment, retrieving other fragments referred to by fragment references in the root fragment, retrieving further fragments referred to by fragment references in those fragments, and so on. In some embodiments, any fragment can be treated as a document, in the sense that it can be opened by an editing or presentation application as the root fragment.

In some embodiments, the facility also stores each document comment as a fragment. In some embodiments, the facility represents a comment in the document in which it is under by including, in a content fragment of the document such as the document's root fragment or a fragment of the document to which the comment particularly applies, a fragment reference to the comment fragment containing the comment. When the document is materialized for display, the facility uses the fragment references that refer to comment fragments to display visual indications of the comments within the document, such as visual indications that identifies (1) the portion of the document to which the comment applies, and (2) the person who made the comment.

In some embodiments, the facility represents a threaded view of comments as a threaded view fragment containing, for each comment shown in the threaded view, a fragment reference referring to the comment fragment containing the fragment. To display the threaded view, the facility materializes the threaded view fragment, which collects and displays the content of the referenced comments together in the threaded view.

In some embodiments, the facility stores both content fragments making up users' documents and comment fragments in a cloud-based service, where they can be accessed from virtually any location. In some embodiments, this cloud-based service uses a technique called “erasure coding” in which it decomposes, or “shreds,” a fragment defined by a document author into multiple smaller constituent pieces, or “shreds,” each of which the facility stores on multiple storage devices in different data centers in different geographic locations to provide disaster and outage survivability. When the cloud-based service receives a request for a fragment, it retrieves and combines these shreds to reconstitute the fragment.

In some embodiments, the facility stores a new version of a fragment to reflect each editing action performed on the fragment, each identified by the date and time at which the editing action was performed. For example, in some embodiments, the facility creates a new fragment version for each character or group of characters that is inserted in the fragment—such as by a keystroke or a text block paste—and for each character or group of characters that is deleted—such as by a backspace keypress or a select-and-delete operation. In some embodiments, each fragment version identifies the author that took the editing action reflected by the fragment version. In some embodiments, after being written, these fragment versions cannot be altered, and are said to be “immutable.”

In some embodiments, over time, the facility deletes some of the versions of a fragment, so as to collapse two or more editing actions into an undeleted version of the fragment. In some embodiments, in doing so, the facility deletes only contiguous fragment versions all reflecting editing actions by the same author and immediately preceding an undeleted fragment version also reflecting an editing action by the same author.

In some embodiments, where the content is incorporated from a fragment-aware source document, the facility ensures that the incorporated content corresponds precisely to one or more whole fragments; that is, where the selected content spans only a portion of a fragment in the source document, the facility breaks that fragment in the source document into two fragments, a first that contains only the content from the original fragment that was selected, a second containing the content from the original fragment that was not selected, so that the first can be incorporated into the target document while the second is not. Where the content is incorporated from a fragment-unaware source document, the facility creates a new fragment to contain the incorporated content.

In response to the incorporation operation, the facility creates a fragment reference in the target document at the position in the target document where the content was incorporated to represent the incorporated content in the target document. In some embodiments, the fragment reference contains multiple components, such as a current fragment ID component and/or an original component. The current fragment ID component of the created fragment reference identifies the fragment to which the reference refers, such as by containing a fragment ID for this fragment that can be used to retrieve this fragment. The origin component, where used by the facility, maintains in the fragment reference state the fragment ID of the fragment in which the incorporated content originated, which can serve as a basis for changing the mode in which the incorporated content is used in the target document throughout the life of the fragment reference, and for tracking the provenance of the fragment. In some embodiments, the facility stores an ordered list of fragment IDs in the origin component to reflect the series of fragments from which the referenced fragment has been forked.

In various embodiments, at the time the user performs the incorporation operation, the user can specify an initial mode for the incorporated content in the target document by, for example, holding down a certain keyboard key during the drag interaction, using a varying control key combination to paste the incorporated content into the target document, responding to a context menu or dialog displayed by the facility in response to the incorporation operation, etc. In some embodiments, each mode has two characteristics: (1) whether the contents of the fragment are editable in the context of the incorporating document or fragment (“editable in context”) and (2) how a version of the referenced fragment is chosen for inclusion in the incorporating document or fragment (“version selection”). In some embodiments, the following kinds of version selection options are available: (a) “latest”—the version of the fragment with the most recent time is incorporated by the reference; (b) “time-specified”—a particular version of the fragment associated with a particular time is incorporated by the reference (e.g., in some embodiments, an arbitrarily specified time causes selection of the fragment version whose time is the latest among the fragments that are not later than the specified time); (c) “special”—special rules are used to specify which version of the fragment is selected for incorporation. Examples of special rules are the latest document approved by a qualified approval authority, or the earliest version embodying an edit by a particular author.

In various embodiments, the facility supports some or all of the following incorporation modes: live mode, follow mode, forkable mode, pinned mode, special forkable mode, and special follow mode.

Live mode (1) is editable in context and (2) uses “latest” version selection. Thus, in live mode, an author can change the content of the fragment, which results in a new version of the fragment being created to reflect each such change. These changes will appear in any other containing fragments that incorporate the same fragment, and whose version selection option ends up selecting this version, either (a) latest, or (b) special with a selection rule that selects this version. Live mode is typically used for a reference included to both revise the referenced fragment, and reflect the revisions of others. By virtue of using the latest version selection option, a reference in live mode incorporates the latest version of the fragment, no matter its content or which authors' revision it reflects. Where live mode is selected, the facility populates a current fragment ID component of the fragment reference with the same fragment ID as the origin component. The current component of the fragment reference identifies the fragment whose contents are to be retrieved for inclusion in the target document.

Follow mode (1) is not editable in context, and (2) uses latest version selection. In follow mode, the latest version of the fragment is always incorporated, but can't be edited in the context of the document or fragment containing the follow mode reference. Follow mode is typically used to incorporated dynamic content maintained by one or more other authors, in a centralized manner.

Forkable mode (1) is editable in context, and (2) uses time-specified version selection. In forkable mode, the fragment can be edited in the context of the reference from the fragment's state at the specified time. Performing such an edit transforms the reference from forkable mode to live mode; reflects the edit in the first version of a new fragment ID; stores the new fragment ID in the context of the reference; and stores the original fragment ID in the reference's origin component. Forkable mode is typically used where a particular state of a fragment is to be the basis for a new set of edits that won't affect documents or fragments incorporating the original fragment. Similarly, the forkable and resulting live reference aren't affected by edits to the original fragment subsequent to the forkable reference version selection time.

Pinned mode (1) is not editable in context, and (2) uses time-specified version selection. While the fragment reference is in pinned mode, the incorporated content cannot be changed, either by a user editing the document or fragment containing the pinned reference (because not editable in context precludes editing by such an author), or by a user editing the fragment in the context of a different containing document or fragment (because such edits will be reflected in a new version of the fragment, which will not be selected by the time-specified selection logic of this reference). Where pinned mode is selected, the facility populates the current component of the fragment reference with the fragment ID of the origin fragment. Pinned mode is typically used to preserve a particular state of the fragment in the referring document.

Special forkable mode (1) is editable in context, and (2) specifies a special version selection rule. The incorporated fragment will, at any given time, show the content of the version of the source fragment that is selected by the special version selection rule at the time. When an author edits the fragment in context, the forking process described above occurs. Special forkable mode can be used, for example, to use an evolving template whose edits are subject to periodic approval as a basis for creating instances of new content.

Special follow mode (1) is not editable in context, and (2) specifies a special version selection rule. Thus, a special follow reference shows the version of the fragment that satisfies the version selection rule at any given time, which is not editable in context. This mode can be used, for example, to pull into a document or fragment centrally-authored content that is periodically rereleased by its authors to reflect all edits occurring since the last release.

A user may at any subsequent time change the mode of the incorporated content via various user interface techniques, such as by right-clicking on the incorporated content and selecting an item from a resulting context menu, selecting incorporated content and choosing a menu-bar menu item, interacting with a specialized control that is displayed when the mouse cursor hovers over the incorporated content, etc. In some embodiments, the facility incorporates or interoperates with a system of authority and access controls and other content governance measures limit the actions that can be taken by a particular user with respect to a particular document or fragment in various circumstances, including changing the mode of an existing fragment reference.

In some embodiments, when retrieving the time-specified fragment version for content incorporated in pinned mode, the facility notifies the user if a version of the origin fragment that is more recent than the read-only fragment to enable the user to switch the mode to live, or remain in pinned mode but replace the time specified for the version in the reference with the time corresponding to the latest version.

In some embodiments, the facility maintains metrics on the incorporation of fragments into documents to be able to report on various “hot fragments” measures, which identify fragments that are incorporated into the most total documents, or fragments that have been incorporated into the most documents during a recent period of time, across an organization or another group of users, among a group or category of documents, etc.

By performing in some or all of the ways described above, the facility extracts a significant amount of value from document comments. Also, by operating in some or all of the ways described above, the facility reduces the amount of storage space needed to store documents and their comments, and expedites the retrieval and processing of this information. Additionally, the facility enables human users to more quickly and easily specify information they wish to display, and display new kinds of information not formerly possible.

### Hardware

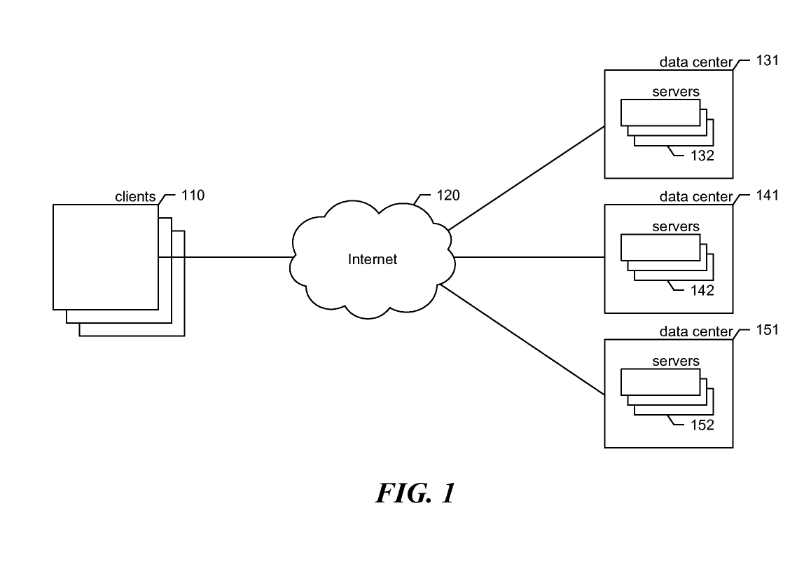

FIG. 1 is a network diagram showing the environment in which the facility operates in some embodiments. The network diagram shows clients 110 each being used by a different user. Each of the clients executes software enabling its user to create, revise, and present electronic documents. Software on the client also enables the client to retrieve and synthesize remotely-stored document contents, including document fragments. In particular, the Internet 120 or one or more other networks connect each of the clients to a number of different data centers, e.g., data centers 131, 141, and 151, which in some embodiments are distributed geographically to provide disaster and outage survivability, both in terms of data integrity and in terms of continuous availability. Distributing the data centers geographically also helps to minimize communications latency with clients in various geographic locations. Each of the data centers contain servers, e.g. servers 132, 142, and 152. The servers access storage devices containing document contents, including document fragments, and execute software for responding to requests from clients and other servers to store and retrieve document contents, again including document fragments. In various embodiments, the facility uses various different distributions of responsibility for retrieving and combining document fragments between the clients and the servers.

While various embodiments are described in terms of the environment described above, those skilled in the art will appreciate that the facility may be implemented in a variety of other environments including a single, monolithic computer system, as well as various other combinations of computer systems or similar devices connected in various ways. In various embodiments, a variety of computing systems or other different devices may be used as clients, including desktop computer systems, laptop computer systems, automobile computer systems, tablet computer systems, smart phones, personal digital assistants, televisions, cameras, etc.

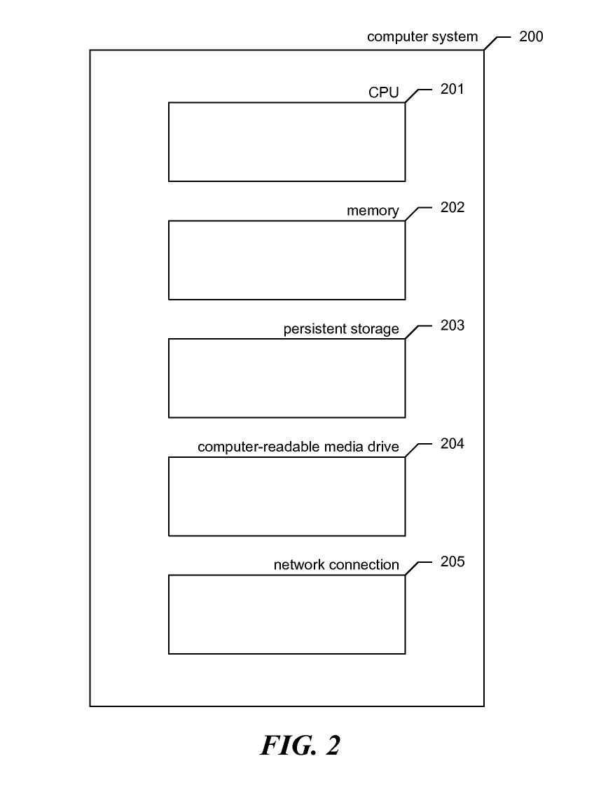

FIG. 2 is a block diagram showing some of the components typically incorporated in at least some of the computer systems and other devices on which the facility operates. In various embodiments, these computer systems and other devices 200 can include server computer systems, desktop computer systems, laptop computer systems, netbooks, mobile phones, personal digital assistants, televisions, cameras, automobile computers, electronic media players, etc. In various embodiments, the computer systems and devices include zero or more of each of the following: a central processing unit (“CPU”) 201 for executing computer programs; a computer memory 202 for storing programs and data while they are being used, including the facility and associated data, an operating system including a kernel, and device drivers; a persistent storage device 203, such as a hard drive or flash drive for persistently storing programs and data; a computer-readable media drive 204, such as a floppy, CD-ROM, or DVD drive, for reading programs and data stored on a computer-readable medium; and a network connection 205 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

### Fragment Management

A user can incorporate pre-existing content into a target document by, for example, selecting that content within the source document, then performing interactions for transferring the selected content to a particular position in the target document. In various embodiments, such interactions can be, for example, placing the selected content on the clipboard, then pasting it into the target document at the target position; dragging the selected content from the source document to the target position in the target document; etc.

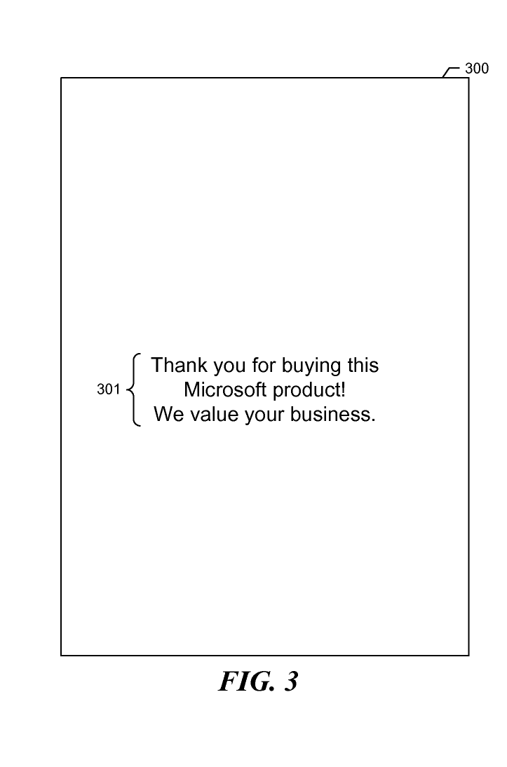

FIGS. 3-5 are display diagrams showing the editing and display of a document incorporating a shared document fragment. FIG. 3 is a display diagram showing a sample target document at a time before the shared document fragment is incorporated. The target document 300 includes text 301. This text may be directly contained by the root fragment for the target document, or may be contained by a fragment identified by a fragment reference within the root fragment for the target document.

FIG. 4 is a display diagram showing the sample target document at a time immediately after the shared document fragment is incorporated. At this time, the target document 400, in addition to containing text 401, contains incorporated content 410 transferred from a source document (not shown). The incorporated content constitutes a company's letterhead, including both an image 411 of the company's logo and the company's textual address 412.

Where the user incorporates the letterhead content in pinned mode, the letterhead content will remain unchanged in the target document unless and until the incorporation is changed to a different mode. Where the user incorporates the letterhead content in forked mode, the user can change the letterhead content in the context of the target document; such changes will not affect the letterhead content in the source document, and any changes to letterhead content in the source document will not be reflected in the target document. Where the user incorporates the letterhead content in live mode, the user can, subject to any applicable permissions, change the letterhead content in the context of the target document, and doing so will change the letterhead content in the source document and any other document that incorporates the letterhead content in live mode. Similarly, changes to the letterhead content via the source document or any other document that incorporates the letterhead content in live mode will be reflected in the target document.

FIG. 5 is a display diagram showing the sample target document where, after the shared document fragment is incorporated into the target document in live mode, the content is changed in the context of the source document, such as by another user. It can be seen that, in the target document 500 at this time, the letterhead content 510 contains a new company logo 511 and a new company address 512, both substituted in the context of the source document, and reflected in the target document pursuant to the target document's incorporation of this content in live mode.

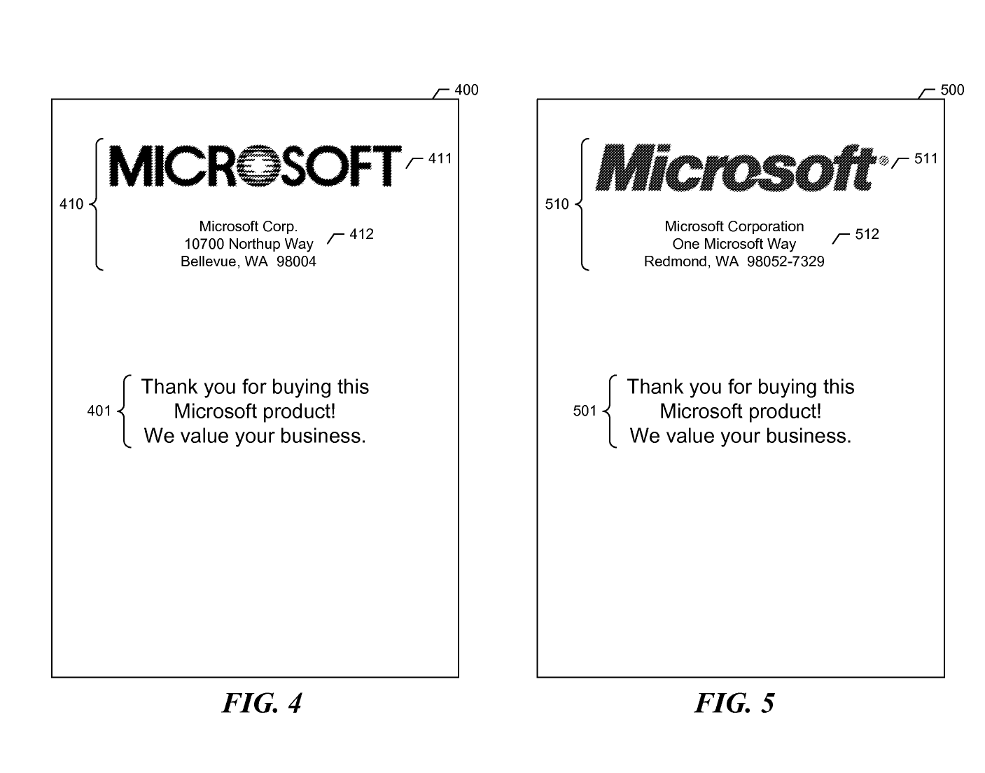

FIG. 6 is a flow diagram showing steps typically performed by the facility in some embodiments in order to incorporate a document fragment into a document, and adjust the mode of its incorporation. In step 601, the facility receives a user interaction to add a fragment to a target document. In various embodiments, such interactions can be, for example, copying the selected content onto the clipboard, then pasting it into the target document at the target position; dragging the selected content from the source document to the target position in the target document; etc. Where the user selects content to add to the target document that don't exactly correspond to whole existing fragments, the facility creates one or more fragments to which the selected content does exactly correspond, such as by subdividing fragments that occur in the source document. In some cases, this involves altering and/or adding fragment references in the source document, and in one or more other documents incorporating the same content in live mode.

In step 602, the facility creates a fragment reference in the target document. In step 603, the facility populates both the origin component of the fragment reference and its current component with the fragment ID of the fragment added to the document. In step 604, the facility receives a user interaction specifying a mode for incorporating the fragment in the target document. In some embodiments, a single interaction or a related sequence of interactions can both add the fragment to the document and specify a mode. If the user action received in step 604 specifies the live mode, then the facility continues in step 605; if it specifies the follow mode, then the facility continues in step 606; if it specifies the forkable mode, then the facility continues in step 607; if it specifies the pinned mode, then the facility continues in step 612; if it specifies the special forkable mode, then the facility continues in step 613; and if it specifies the special follow mode, then the facility continues in step 614.

In step 605, where the live mode is specified, the facility sets edit in context to yes for the reference, and sets version selection to latest. After step 605, the facility continues in step 604 to permit the user to, at a later time, specify a new mode for this fragment. In step 606, where the follow mode is specified, the facility sets edit in context to no for the reference, and sets version selection to latest. After step 606, the facility continues in step 604. In step 607, where the forkable mode is specified, the facility sets edit in context to yes for the reference, and sets version selection to the current time, or an earlier time selected by the user. In step 608, if the user chooses to edit the fragment in the context of the reference, then the facility continues in step 609, else the facility continues in step 604. In step 609, the faculty creates a new fragment that reflects application of the edit of step 608 to the added fragment. The new fragment has a different fragment ID than the added fragment. In step 610, the facility populates the current component of the fragment reference with the new fragment's fragment ID. In step 611, the facility changes the reference's mode to live. After step 611, the facility continues in step 605. In step 612, where the pinned mode is specified, the facility sets edit in context to no for the reference, and sets version selection to the current time, or to an earlier time selected by the user. After step 612, the facility continues in step 604. In step 613, where the special forkable mode is specified, the facility sets edit in context to yes, and sets version selection to a version selection rule, such as a version selection rule specified via additional user interactions, a default version selection rule, an inferred version selection rule, etc. After step 613, the facility continues in step 608. In step 614, where the special follow mode is specified, the facility sets edit in context to no, and sets version selection to a version selection rule in a manner similar to step 613. After step 614, the facility continues in step 604.

Those skilled in the art will appreciate that the steps shown in FIG. 6 and in each of the flow diagrams discussed below may be altered in a variety of ways. For example, the order of the steps may be rearranged; some steps may be performed in 4parallel; shown steps may be omitted, or other steps may be included; a shown step may be divided into sub steps, or multiple shown steps may be combined into a single step, etc.

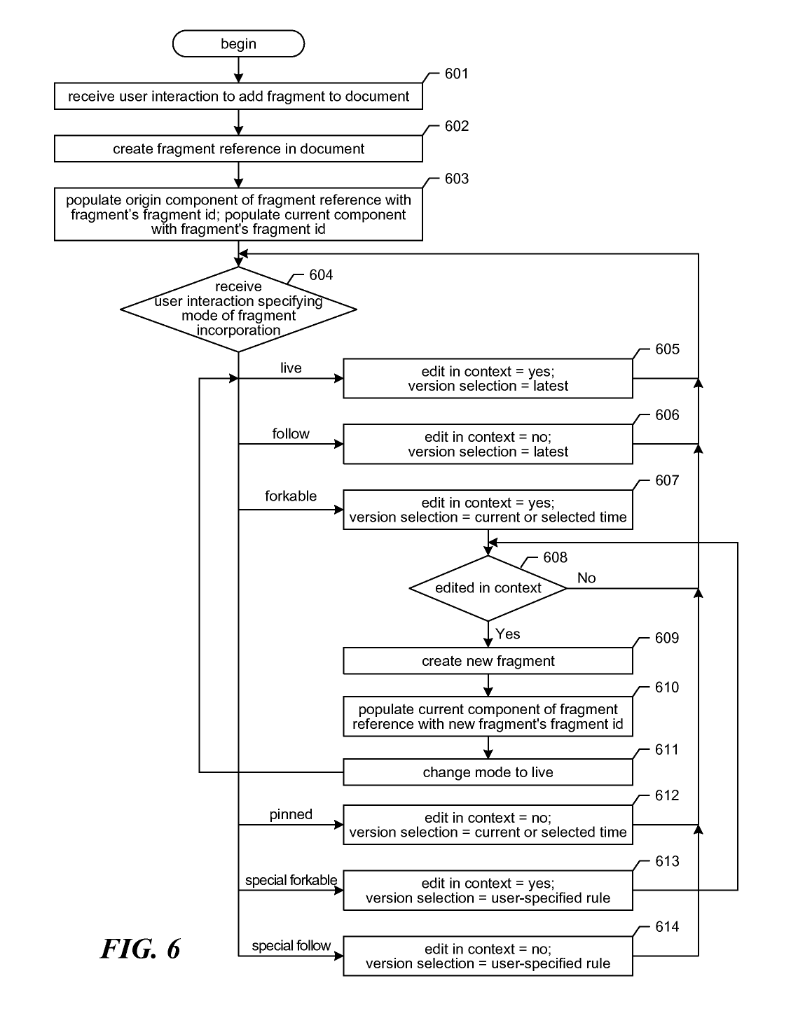

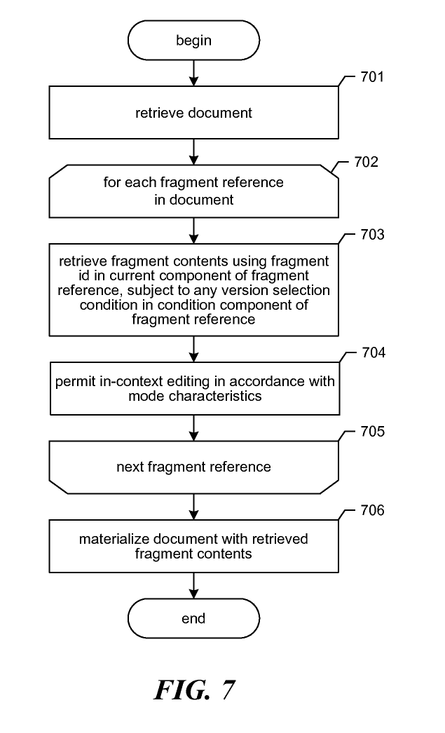

FIG. 7 is a flow diagram showing steps typically performed by the facility in some embodiments in order to materialize a document containing shared fragments. In various embodiments, the facility performs these steps when a document is opened, when a document needs to be displayed, when a user attempts to add it to document, etc. In various embodiments, the facility's performance of these steps is distributed between the client and servers in various ways. In step 701, the facility retrieves a document, such as by retrieving its root fragment. The facility loops through steps 702-704 for each fragment reference occurring in the document, including transitive fragment references from one fragment to another. In step 703, the facility retrieves content of the fragment using the fragment ID contained in the current component of the fragment reference. This retrieval is subject to any version selection condition contained in the condition component of the fragment reference; that is, the retrieval is performed with respect to the latest version of the fragment that specifies any contained version selection condition, or, absent a version selection condition, the latest version of the fragment. In various embodiments, the facility uses various forms of fragment version selection logic. In some embodiments, the process of retrieving a fragment indicates permissions associated with the fragment, including whether the fragment can be edited by the current user, which the facility uses to indicate and control whether the user can edit the fragment in the context of the document. Fragment retrieval is discussed in greater detail below in connection with FIGS. 8-11. In step 704, the facility makes the fragment editable in context based on the mode of the fragment reference. In step 705, if additional fragment references remain to be processed, then the facility continues in step 702 to process the next fragment reference, else the facility continues in step 706. In step 706, the facility materializes the document using the fragment contents retrieved in step 703. After step 706, these steps conclude. In some embodiments (not shown), rather than performing the processing shown in FIG. 7 in a loop, the facility performs it as a recursive descent of a tree-like graph with lenses acting as parents of content nodes, and modifying rendering behavior as the document is materialized.

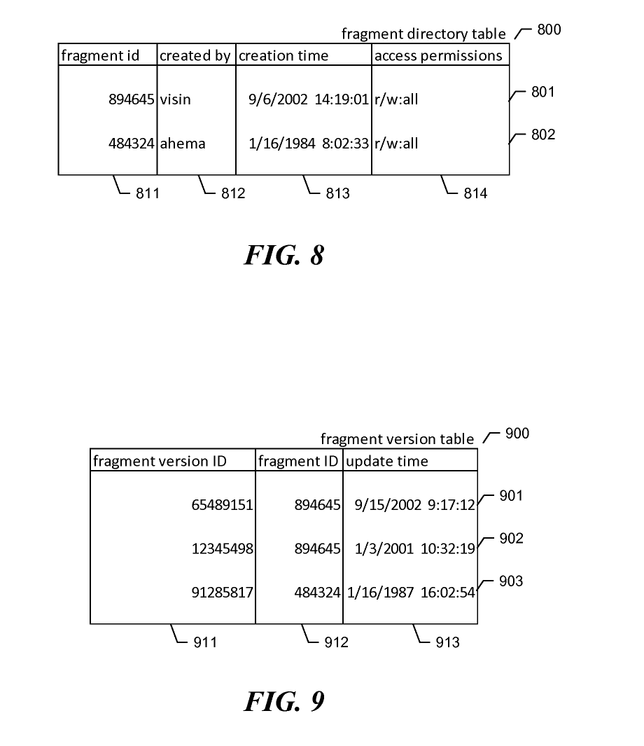

FIG. 8 is a table diagram showing sample contents of a fragment directory table used by the facility in some embodiments to store information about fragments. In some embodiments, the fragment directory table, and the other tables described in FIGS. 9-11, are stored in a data center on a storage device accessible to servers executing server software that is part of the facility. In some embodiments, some or all of these tables are stored in multiple data centers in order to provide survivability and a measure of locality for the data they store. The fragment directory table 800 is made up of rows such as rows 801-802 each corresponding to a different fragment. Each row is divided into the following columns: a fragment ID column 811 containing a fragment ID identifying the fragment to which the row corresponds; a created by column 812 containing information identifying a user that created the fragment; a creation time column 813 having contents indicating the time at which the fragment was created; and an access permissions column 814 specifying the ways in which the fragment can be accessed by various users. For example, row 801 indicates that a fragment having fragment ID 894645 was created by user visin at 9/6/2002 14:19:01, and can be read and written by all users. In some embodiments, the facility employs geographically-invariant times, such as times expressed in Greenwich Mean Time, in order to coordinate servers and clients located in different time zones. Where the server receives a retrieval request for fragment ID 894645, it uses row 801 to determine access permissions for this fragment.

While FIG. 8 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed, encrypted, and/or indexed; may contain a much larger number of rows than shown, etc.

FIG. 9 is a table diagram showing sample contents of a fragment version table used by the facility in some embodiments to store information about fragment versions. In particular, the facility uses the fragment version table to identify the different versions of a fragment that exist, and their time order. In some embodiments, the facility maintains only a single version of each fragment, in which case the fragment version table is not necessary, and fragment IDs are substituted for fragment version IDs in other tables maintained by the facility. The fragment version table 900 is made up of rows such as rows 901-903 each corresponding to a different fragment version. Each of the rows is divided into the following columns: a fragment version ID column 911 containing a fragment version ID for the fragment version to which the row corresponds that uniquely identifies this fragment version; a fragment ID column 912 containing the fragment ID identifying the fragment to which this fragment version corresponds; and an update time column indicating the time at which the fragment version was last updated. For example, row 901 indicates that the fragment version having fragment version ID 65489151 corresponds to the fragment having fragment ID 894645, and was last updated at 9/15/2002 9:17:12. Where the server receives a retrieval request for fragment ID 894645, it uses rows 901 and 902 to identify the two fragment versions that exist for this fragment ID. These two rows can also be used to determine which of the fragment versions is more recent.

In some embodiments, where fragment versions are used, some fragment versions are writeable, such that an author can change the content at a time after it is created, at least in the case of fragment versions that are not referenced by any pinned fragment references. However, in some embodiments, every fragment version is read-only, and any revision of content contained by an existing fragment version causes the facility to create a new fragment version. In various embodiments, the creation of a new fragment version occurs at various levels of granularity, including a new fragment version for each editing session, a new fragment version for each keystroke, or at some level in between, such as every five seconds, every minute, every 15 minutes, etc.

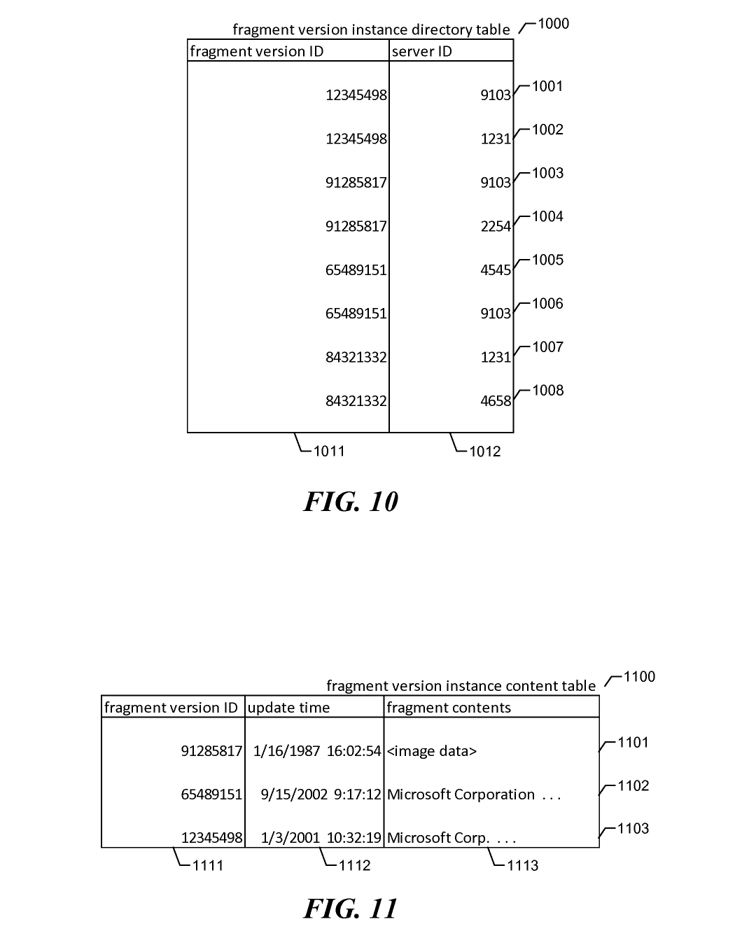

FIG. 10 is a table diagram showing sample contents of a fragment version instance table used by the facility in some embodiments to store information about fragment version instances. In particular, the facility uses the fragment version instance directory table to identify, for particular fragment version, instances of the fragment version that are stored on different servers, so that the facility can choose one of the fragment versions for retrieval, and so that, if a fragment version is being changed in an embodiment where this is possible, every instance of it can be changed or invalidated. The fragment version instance directory table 1000 is made up of rows such as rows 1001-1008 each corresponding to a different combination of a fragment version and a server on which an instance of the fragment version is stored. Each row is divided into the following columns: a fragment version ID column 1011 containing if fragment version ID identifying the fragment version; and a server ID column 1012 identifying a server on which an instance of the fragment version is stored. For example, row 1001 indicates that the fragment version having fragment version ID 12345498 has an instance stored on the server having server ID 9103. In various embodiments, the facility uses various other approaches to identifying locations in which instances of fragment versions are stored, such as by using data center IDs, storage device IDs, etc.

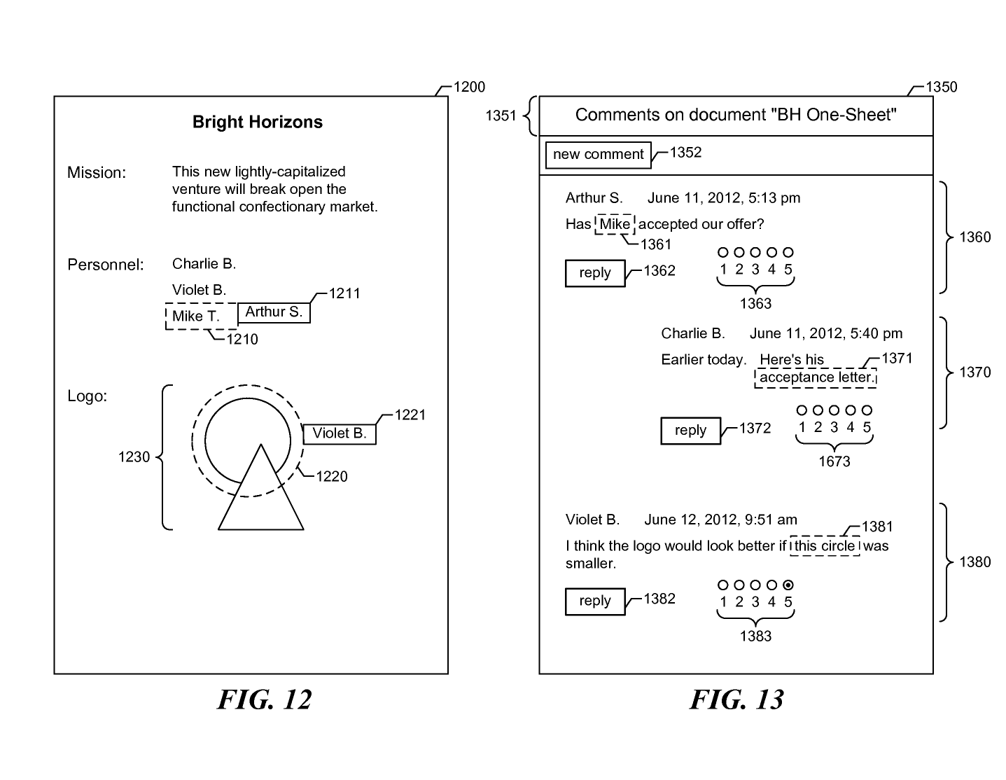

FIG. 11 is a table diagram showing sample contents of a fragment version instance content table used by the facility in some embodiments to store fragment version instance content. The fragment version instance content table 1100 is made up of rows such as rows 1101-1103 each corresponding to fragment version instances all stored on a particular server. The fragment version instance content table 1100 is, in particular, stored on the server having server ID 9103. Each of the rows is divided into the following columns: a fragment version ID column 1111 containing the fragment version ID identifying the fragment version to which the row corresponds; an update time column 1112 indicating the time at which the fragment version instance was last updated; and a fragment contents column 1113 containing the contents of the fragment version instance. For example, row 1101 indicates that the fragment version instance having fragment version ID 91285817 and update time Jan. 16, 1987 16:02:54 contains particular image data. It is the fragment 1113 that contains the data that the facility returns in response to a fragment retrieval request.

In some embodiments, rather than storing each fragment version instance as a single entity as shown in FIG. 11, the facility employs an “erasure coding” technique in which it distributes the contents of each fragment version instance as any number of smaller shreds, which can be stored on any arrangement of servers.

### Comment Creation, Maintenance, and Analysis

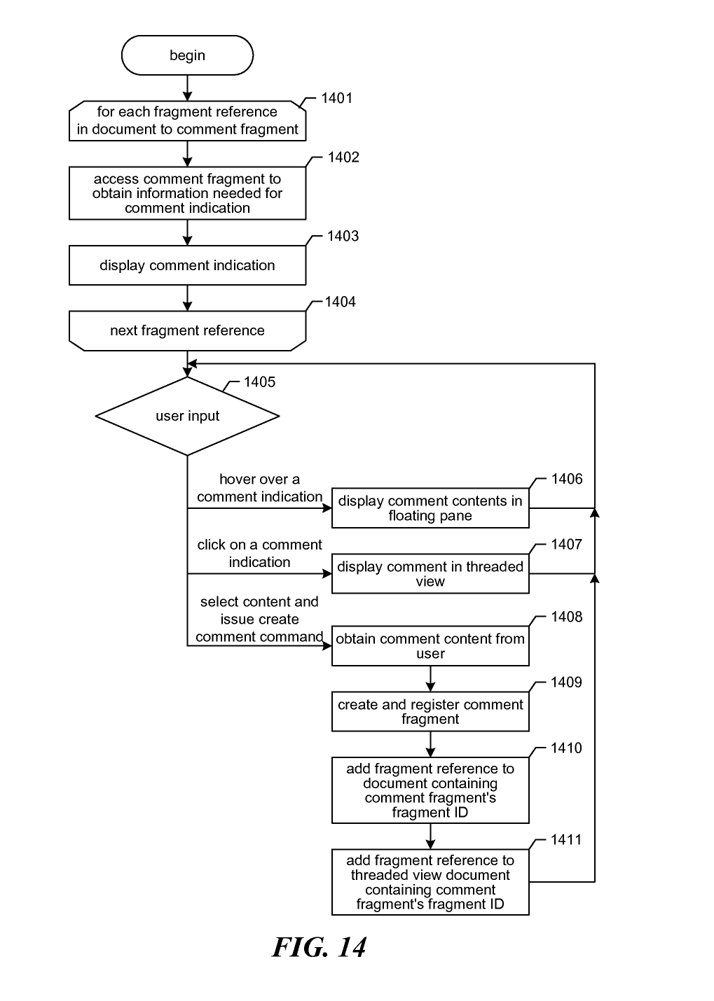

FIGS. 12 and 13 are display diagrams showing a sample visual user interface used by the facility in some embodiments in order to create, display, and interact with document comments. FIG. 12 is a display diagram showing sample contents of a document to which comments have been added. It can be seen that the display 1200 contains contents of a “one-sheet” document. The document contents include highlighted text 1210 that is the subject of a first comment, as indicated by visual content indication 1211 that, in this example, contains the name of the user who created the comment. In the example, text 1210 is part of the root fragment for the display document, which is a text fragment. The displayed document further includes a portion 1230 that is stored in a drawing fragment that is a child fragment of the document's root fragment. Highlighting 1220 identifies a circle within the drawing, and visual comment indication 1221 indicates that a comment by user Violet B. is attached to this highlighted circle.

In various embodiments, the user can interact with the comments in this document in various ways. For example, in some embodiments, the user can hover over a visual comment indication to display the content of the corresponding comment, such as in a floating plane that floats above the visual comment indication. In some embodiments, the user can click on a visual comment indication in order to display more information about the comment, such as to display contents of the comment and metadata for the comment in the context of a threaded discussion of which the comment is part, such as a threaded discussion about this document; a portion of this document; a group of documents that includes this document; etc. In some embodiments, the user may add his or her own comment to this document, such as by selecting a portion of the document and issuing a create comment command, such as by typing a key combination, selecting an item from a right-click context menu, selecting an item from a drop-down menu or toolbar, etc.

FIG. 13 is a display diagram showing a sample threaded comment view display presented by the facility in some embodiments. The display 1350 contains information 1351 about the subject of the threaded view, here the single document shown in FIG. 12. The display also includes three comment entries 1360, 1370, and 1380. Each comment entry begins with a line containing metadata about the comment, here identifying information for the content creator and the date and time at which the comment was created. For example, the first line of comment entry 1360 indicates that this comment was created by a user named “Arthur S.” on Jun. 11, 2012 at 5:13 pm. After its first line, each comment entry contains the content of the comment. For example, the second line of content entry 1360 contains the comment content “Has Mike accepted our offer?” In some cases, the content of the comment includes highlighted text constituting a link to a particular portion of a particular document. In comment entry 1360, the text “Mike” is highlighted, and constitutes a link to document portion 1210 shown in FIG. 12. In some embodiments, the user can click anywhere on the comment content or the entire comment entry to follow a link to the document portion to which the comment is attached. In some embodiments, the user can click on the commenter name in order to view a set of comments from the same commenter, such as recent comments from the same commenter. As shown in FIG. 13, the level of indentation indicates which comments are replies to the comment that they succeed. In particular, because the comment entry 1370 is indented relative to preceding comment entry 1360, the comment of comment entry 1370 is a reply to the comment of comment entry 1360. On the other hand, because content entry 1360 and 1380 are at the left hand margin, they are not replies to any comment.

While display 1350 is being presented, the user can rate the value of any of the comments by selecting a rating radio button. For example, it can be seen from radio buttons 1383 in comment entry 1380 that this user has earlier rated the comment of comment entry 1380 5-5, the highest available rating. In some embodiments, the facility aggregates these ratings as a basis for valuing comments. The user can also click on highlighted links to follow them to the corresponding portions of linked-to documents, such as clicking on link 1361 to view document portion 1210. The user can also create a new comment in the thread. To reply to an existing comment, the user clicks the reply button in its comment entry. For example, to reply to the comment of comment entry 1380, the user clicks reply button 1382. To create a new comment in the thread that is not a reply to any other comment, the user clicks new comment button 1352.

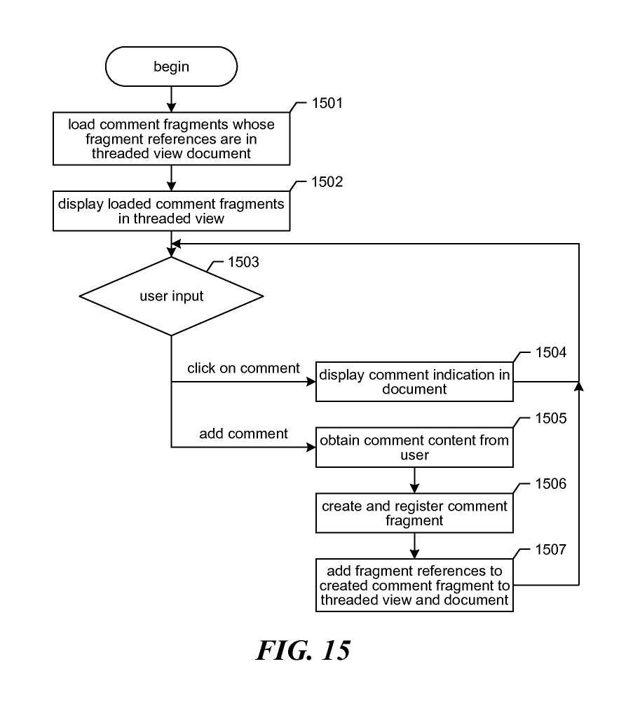

FIGS. 14 and 15 are flow diagrams showing steps typically performed by the facility in connection with presenting the visual user interface shown in FIGS. 12 and 13. FIG. 14 is a flow diagram showing steps typically performed by the facility in some embodiments in connection with presenting the document display shown in FIG. 12. The facility typically performs these steps when a user issues a command to open a document that contains comments, or when a user follows a link from a comment in a context outside the document commented upon, such as from the threaded comment view shown in FIG. 13.

In steps 1401-1404, the facility loops through each fragment reference to a comment fragment that occurs in the document just loaded by the facility, such as by loading the document's root fragment and each fragment descending directly or indirectly therefrom. In some embodiments, these fragment references to comment fragments may be distributed among the fragments making up the document. In step 1402, the facility accesses the comment fragment referenced by the current fragment reference in order to obtain information needed to display a visual comment indication for the comment. In step 1403, the facility displays in the context of the displayed document a visual indication for the comment using information accessed in step 1402, such as highlighting 1210 and visual indication 1211 shown in FIG. 12. In step 1404, if additional fragment references to comment fragments remain to be processed, then the facility returns to step 1401 to process the next such fragment reference, else the facility continues in step 1405.

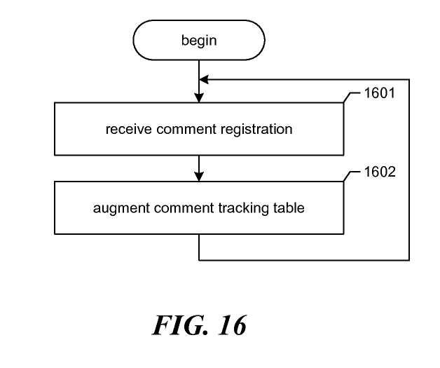

In step 1405, the facility monitors for user input, and branches on the type of user input received. Where the type of user input received in step 1405 is to hover over a comment indication, the facility continues in step 1406; where the type of user input is clicking on or otherwise selecting a comment indication, the facility continues in step 1407; and when the type of user input is selecting content and issuing a create comment command, the facility continues in step 1408. In step 1406, where user input has been received to hover a mouse cursor over a visual comment indication displayed in the document, the facility displays the contents of this comment in a floating pane floating above or near the comment indication. After step 1406, the facility returns to step 1405 to receive the next user input. In step 1407, where user input has been received that corresponds to clicking on or otherwise selecting (via touch, stylus, etc.) a comment indication, the facility displays the corresponding comment in a threaded view, such as the threaded view shown in FIG. 13. After step 1407, the facility returns to step 1405 to process the next user input. In step 1408, where user input is received selecting content and issuing a create comment command, the facility obtains comment content from the user; this can correspond to, for example, the comment content shown in comment entries 1360, 1370, and 1380 in FIG. 13. In step 1409, the facility creates and registers a new comment fragment based upon the content selected in the document and, the comment content obtained in step 1408 and automatically determined metadata such as user identity and creation time. Registration of the comment is for purposes of analyzing comments centrally, and is discussed further below in connection with FIG. 16. In step 1410, the facility adds a fragment reference to the displayed document that contains the fragment ID of the comment fragment created in step 1409. In step 1411, the facility similarly adds such a fragment reference to a threaded view document that is the basis for threaded view display 1350 shown in FIG. 13. After step 1411, the facility returns to step 1405 to process the next user input.

FIG. 15 is a flow diagram showing steps typically performed by the facility in some embodiments in connection with presenting the threaded comment display shown in FIG. 13. In step 1501, the facility loads comment fragments whose fragment references are in the threaded view document. In the example shown in FIG. 13, the facility in step 1501 loads the three comment fragments corresponding to the three comment entries 1360, 1370, and 1380 shown in FIG. 13. In step 1502, the facility displays in the threaded view 1350 the comment fragments loaded in step 1501. In step 1503, the facility monitors for user input, and branches on its type. For user input reflecting a click on or other selection of a comment, the facility continues in step 1504; for user input representing the selection of any of the controls in display 1350 for adding a new comment, the facility continues in step 1505. In step 1504, where user input is received representing a click on or other selection of a comment, the facility displays the comment indication corresponding to the comment in the context of the document, i.e., display 1200 shown in FIG. 12. After step 1504, the facility returns to step 1503 to process the next user input. In step 1505, where the user input is received reflecting the selection of an add comment command, the facility obtains comment content for the new comment from the user. In step 1506, in a manner similar to step 1409 described above, the facility creates and registers a new comment fragment. In step 1507, in a manner similar to steps 1410 and 1411 described above, the facility adds to both the threaded view fragment the document commented upon a fragment reference that refers to the comment fragment created in step 1506. After step 1507, the facility returns to step 1503 to process the next user input.

FIG. 16 is a flow diagram showing steps typically performed by the facility in some embodiments in order to register a newly-created comment fragment. In step 1601, the facility receives the comment registration. In step 1602, the facility augments a comment tracking table or other similar resource to reflect creation of the comment as a basis for comment analysis. After step 1602, the facility returns to step 1601 to receive the next comment registration.

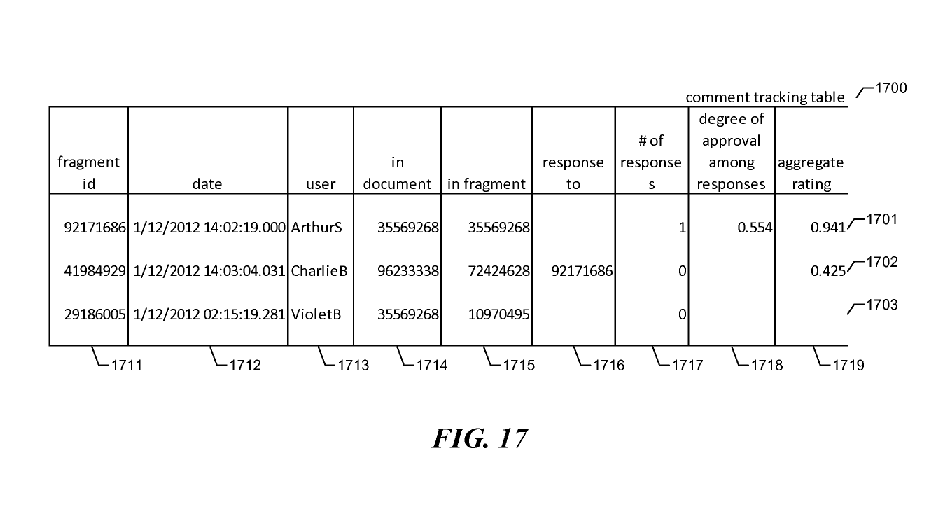

FIG. 17 is a table diagram showing sample contents of a comment tracking table maintained by the facility in some embodiments in order to centrally represent document comments created by the facility as a basis for comment analysis. The table 1700 is made of rows, such as rows 1701-1703, each corresponding to a different comment. Each of the rows is divided into the following columns: a fragment ID column 1711 containing the fragment ID that can be used to retrieve the comment fragment that stores the content of the comment; a date column 1712 that indicates the date and time at which the comment was created; a user column 1713 containing identifying information for the user who created the comment; an in document column 1714 containing the fragment ID usable to retrieve the root fragment of the document in which the comment was made; an in fragment column 1517 containing the fragment ID usable to retrieve the fragment among the fragments representing the document that contains the document content to which the comment is attached; a response to column 1716 containing the fragment ID of any comment fragment storing the content of a comment to which the present comment is a response; a number of responses column 1717 indicating the number of comments that have been created as responses or replies to this comment; a degree of approval among responses column 1718 reflecting a determination by the facility of the extent to which comments that respond to this comment approve of this comment; and an aggregate rating column 1719 that contains an aggregation of the ratings attributed to the comment by other users. For example, row 1701 corresponds to the comment reflected in highlighted text 1210 and visual comment indication 1211 in FIG. 12, and comment entry 1360 in FIG. 13; it indicates that this comment is stored in the comment fragment having fragment ID 92171686, was created on Jan. 12, 2012 at time 14:02:19.000 by user ArthurS; that the comment is attached to text in root fragment 35569268 of a document, is not a response to any other comment, and has one response; has a degree of approval among responses of 0.554 out of 1; and has an aggregate rating among considered users of 0.941. While the comment to which row 1701 corresponds is not a response to any comment, the comment to which row 1702 corresponds is a response to another comment, in particular a response to the comment to which row 1701 corresponds, which has fragment ID 92171686. Those skilled in the art will appreciate that, in a variety of embodiments, a variety of other intermediate and final comment analysis results can be stored by the facility in the comment tracking table and/or elsewhere.

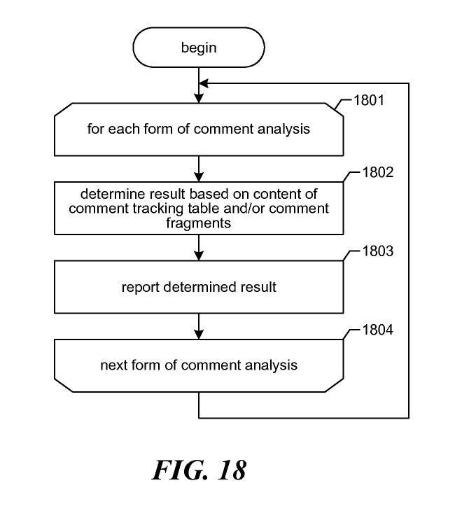

FIG. 18 is a flow diagram showing steps typically performed by the facility in some embodiments in order to update comment analysis results. In steps 1801-1804, the facility loops through each form of comment analysis it is configured to perform. In step 1802, the facility determines a result for the current form of comment analysis based upon on the contents of the comment tracking table, the contents of individual comment fragments, and/or based on a variety of other resources used and/or maintained by the facility. In step 1803, the facility reports the result determined in step 1802. In various embodiments, the facility uses a variety of mechanisms to report these results, including display on a web page, in a document editing application window, or in a document management application window; inclusion in periodically-delivered communications such as e-mail messages, text messages, instant messages, social media platform postings, etc.; voicemail messages; etc. In some embodiments, the facility designs these reports so that recipients can select various documents, document portions, comments, and/or users appearing in the report to follow a link to additional information about those entities. In step 1804, if additional forms of comment analysis remain to be performed, then the facility returns to step 1801 to process the next form of comment analysis, else the facility returns to step 1801 to repeat this cycle, immediately or after the lapse of a certain amount of time.

In various embodiments, the facility performs various forms of analysis on document comments in step 1803. In some embodiments, the facility performs analysis on document comments to identify valued document commenters. For example, in various embodiments, the facility generates the sample analysis results shown below in Table 1 using techniques such as measuring each commenter's volume of comments, reflected in such measures as number, frequency, or recency; assessing the quality of comments created by each commenter, including actions taken by others with respect to the user's comments, including viewing them, responding to them, forwarding them, scoring them, following links from them into documents, etc.

Most valued document commenters during the week of June 8, 2015:

TABLE 1

Marshall H.
Dominique L.
Gianna L.

In some embodiments, the facility performs analysis on document comments to identify users who frequently ask questions in document comments to generate analysis results such as the sample analysis results shown below in Table 2.

Frequent question posers during the week of Jun. 8, 2015:

TABLE 2

Ralph A.
Mark A.
Deb F.

In some embodiments, the facility performs analysis on document comments to identify users who frequently answer questions in document comments to generate analysis results such as the sample analysis results shown below in Table 3.

Frequent question answerers during the week of Jun. 8, 2015:

TABLE 3

Ralph R.
John C.
Donald D.

In some embodiments, the facility performs analysis on document comments to identify users who provided the most valuable answers to questions posed in document comments, sample analysis results for which are shown below in Table 4.

Most valued answerers during the week of Jun. 8, 2015:

TABLE 4

Donald D.
John C.
Thomas U.

In some embodiments, the facility performs analysis of comments to identify important documents. For example, in various embodiments, the facility generates the sample analysis results shown below in Table 5 using techniques such as such as measuring the volume of comments on each document, reflected in such measures as number, frequency, or recency; assessing the quality of comments on each document, including actions taken by others with respect to the comments on a document, including viewing the comments, responding to them, forwarding them, scoring them, following links from them into documents, etc.

Most important documents during the week of Jun. 8, 2015:

TABLE 5

BH One-Sheet
RO One-Sheet
FY2016 Budget

In some embodiments, the facility leverages identification of groups of users as a basis for constraining various kinds of analysis it performs. In various embodiments, the facility performs such identification on the basis of position; subtrees and/or levels within an organizational hierarchy; rank, such as military rank; qualification, such as a professional engineering licensure; job classification; subject matter area specialty; employer; age; sex; document and other data access rights; shared actions or activities; geographic location, including time zone; affinity groups; etc. For example, in some embodiments the facility generates the sample analysis results shown below in Table 6 based upon explicit list of users who are members of a company's Accounting Department.

Most important documents in Accounting Department during the week of Jun. 8, 2015:

TABLE 6

FY2016 Budget
2015May Rent AP
2015June Client AR

In some embodiments, the facility performs analysis of comments to identify important portions of documents, in manners similar to those discussed above use to identify important documents, as illustrated by the analysis results shown below in Table 7.

Most important document portions during the week of Jun. 8, 2015:

TABLE 7

RO One-Sheet, Logo
FY2015 Budget, recurring expenses
BH One-Sheet, personnel

In some embodiments, the facility identifies documents and comments in a particular “space.” In various embodiments, the facility performs such identification based upon documents that share a particular explicit category, such as “employee evaluation;” documents or comments that share a particular attribute, such as those expressed in the French language; documents that are of a particular type, such as business drawing documents; documents or comments with respect to which users in a particular group of users have taken a particular kind action, such as creating, contributing to, viewing, recommending, evaluating, or commenting on; various kinds of lexical analysis, including search queries, natural language processing summaries and other processing techniques, etc. For example, in some embodiments the facility generates the sample analysis results shown below in Table 8 based upon documents identified by lexical analysis seeking to determine whether portions of documents are directed to the concept “mission statement.”

Most important document portions during the week of Jun. 8, 2015 among documents containing mission statement:

TABLE 8

LaunchCo's Objectives
RO One-Sheet, Mission Statement
Accounting 2015June Status Memo, New Directions

In some embodiments, the facility provides a computer system for creating and analyzing document comments. The computer system comprises: a comment input subsystem configured to receive comments each attached to a particular document, the comment input subsystem configured to, for each of a plurality of documents, receive at least one comment attached to the document; a comment information storage subsystem configured to store information about each of the comments received by the comment input subsystem; and an information analysis subsystem configured to collectively analyze the comment information stored by the comment information subsystem. Each of these subsystems is a computing-related entity, comprising either hardware, a combination of hardware and software, software, or software in execution on a computer.

In some embodiments, the facility provides a computer-readable medium having contents configured to cause a computing system to, in order to analyze comments attached to electronic documents: compile a data set reflecting comments attached to each of a plurality of electronic documents; analyze the compiled data set to generate at least one comment analysis result; and output the generated at least one comment analysis result.

In some embodiments, the facility provides a method in a computing system for analyzing comments attached to electronic documents. The method comprises: compile a data set reflecting comments attached to each of a plurality of electronic documents; analyze the compiled data set to generate at least one comment analysis result; and output the generated at least one comment analysis result.

In some embodiments, the facility provides a computer-readable medium storing a comment tracking table data structure. The data structure comprises: a plurality of entries each corresponding to a different document comment, each entry comprising: first information identifying a document to which the document comment is attached; and second information characterizing the document comment in a manner that is subject to comment analysis, across the plurality of entries the first information identifying a plurality of distinct documents, such that the contents of the data structure are usable to collectively analyze the comments attached to the plurality of distinct documents.

### CONCLUSION

It will be appreciated by those skilled in the art that the above-described facility may be straightforwardly adapted or extended in various ways. While the foregoing description makes reference to particular embodiments, the scope of the invention is defined solely by the claims that follow and the elements recited therein.

We claim:

1. A computer system for creating and analyzing document comments, comprising:
a comment input subsystem configured to receive comments each attached to a particular document, the comment input subsystem configured to, for each of a plurality of documents, receive at least one comment attached to the document;
a comment information storage subsystem configured to store information about each of the comments received by the comment input subsystem; and
an information analysis subsystem configured to collectively analyze the comment information stored by the comment information subsystem to obtain comment analysis results.

2. The computer system of claim 1 wherein the comments received by the comment input subsystem are each attached to a particular location in a particular document, further comprising a display subsystem configured to display:
contents of a selected one of the plurality of documents; and
for each comment received by the comment input subsystem that is attached to the selected document, a visual indication of the comment that is positioned near the particular location to which the comment is attached.

3. The computer system of claim 1, further comprising a display subsystem configured to display contents of a proper subset of the comments received by the comment input subsystem, the manner in which the contents are displayed by the display subsystem reflecting relationships between comments of the proper subset of comments.

4. The computer system of claim 1 wherein the information analysis subsystem is configured to collectively analyze the comment information stored by the comment information subsystem by evaluating authors of documents to which the comments received by the comment input subsystem are attached.

5. The computer system of claim 1 wherein the information analysis subsystem is configured to collectively analyze the comment information stored by the comment information subsystem by evaluating authors of comments received by the comment input subsystem are attached.

6. A computer-readable medium having contents configured to cause a computing system to, in order to analyze comments attached to electronic documents:
compile a data set reflecting comments attached to each of a plurality of electronic documents;
analyze the compiled data set to generate a comment analysis result; and
output the generated comment analysis result.

7. The computer-readable medium of claim 6 wherein the comment analysis result comprises identification of at least one document determined to be important based upon comments reflected by the data set.

8. The computer-readable medium of claim 6 wherein the comment analysis result comprises identification of at least one document author determined to be important based upon comments reflected by the data set.

9. The computer-readable medium of claim 6 wherein the comment analysis result comprises identification of at least one document commentator determined to be important based upon comments reflected by the data set.

10. The computer-readable medium of claim 6 wherein the comment analysis result comprises identification of at least one subject of discussion determined to be important based upon comments reflected by the data set.

11. The computer-readable medium of claim 6 wherein the comment analysis result comprises identification of at least one document to recommend to a particular user.

12. The computer-readable medium of claim 6 wherein the contents of the computer-readable medium have contents further configured to cause a computing system to identify the plurality of electronic documents from among a multiplicity of electronic documents on a basis selected from the bases of (1) documents with respect to each of which an action of a particular type has been taken by a user among a group of users; (2) documents with respect to each of which an action of a particular type has been taken during a particular period of time; (3) documents each created in a particular workspace;
(4) documents each being classified in a particular category; and (5) documents each being of a particular type.

13. The computer-readable medium of claim 6 wherein the contents of the computer-readable medium have contents further configured to cause a computing system to identify the plurality of electronic documents from among a multiplicity of electronic documents based on satisfying a search query.

14. The computer-readable medium of claim 6 wherein the contents of the computer-readable medium have contents further configured to cause a computing system to identify the plurality of electronic documents from among a multiplicity of electronic documents based on producing a similar result when subjected to a natural language processing process.

15. A computer-readable medium storing a comment tracking table data structure, the data structure comprising:
a plurality of entries each corresponding to a different document comment, each entry comprising:
first information identifying at least one document to which the document comment is attached; and
second information characterizing the document comment in a manner that is subject to comment analysis,
across the plurality of entries the first information identifying a plurality of distinct documents,
such that the contents of the data structure are usable to collectively analyze the comments attached to the plurality of distinct documents.

16. The computer-readable medium of claim 15 wherein the second information characterizes the document comment by indicating a relative value attributed to the document comment.

17. The computer-readable medium of claim 15 wherein each entry further comprises third information specifying a point in time at which the document comment was created.

18. The computer-readable medium of claim 15 wherein each entry further comprises third information identifying a person who created the document comment.

19. The computer-readable medium of claim 15 wherein each of a proper subset of the plurality of entries further comprises third information identifying an additional document comment to which the document comment is a response.

20. The computer-readable medium of claim 15 wherein each of the document comments comprising document comment contents, each entry further comprising third information usable to retrieve the document comment contents of the document comment.
